(19) United States
(12) Patent Application Publication
(10) Pub. No.: US 2021/0278067 A1
(43) Pub. Date: Sep. 9, 2021

(54) HUNTING MARKER AND METHOD OF USE

(71) Applicant: Terrance Lange, Columbus, WI (US)

(72) Inventor: Terrance Lange, Columbus, WI (US)

(21) Appl. No.: 17/194,900

(22) Filed: Mar. 8, 2021

Related U.S. Application Data
(60) Provisional application No. 62/987,021, filed on Mar. 9, 2020.

(51) Int. Cl. F21V 21/08

(52) U.S. Cl. CPC F21V 21/0824; F21W 2111/02

(57) ABSTRACT

Embodiments are described for a hunting marker that is usable to mark hunting trails when hunting animals. The hunting marker is used to mark any signs of an animal including blood markings, footprints, fur, or any other sign. The hunting marker includes reflective tape and light emitting diodes (LED) to improve visibility of the hunting marker at night. The hunting marker includes one or more batteries. The hunting marker includes a cylindrical body with extendable and retractable portions that can be extended to maximum length and retracted in order to make the hunting marker easily portable and easy to store. The hunting marker includes a pointed end in order to facilitate inserting the hunting marker into a ground surface to mark blood droppings and other animal indicia from a hunted animal or to mark a hunting trail.

### CROSS-REFERENCE TO RELATED APPLICATIONS

This application is a non-provisional application which claims priority to U.S. Provisional Patent Application No. 62/987,021 filed on Mar. 9, 2020, which is incorporated by reference in its entirety.

### FIELD OF THE DISCLOSURE

The present invention relates to a marker that may be used while hunting animals. More specifically, the present invention relates to a marker that may be used for hunting to assist a hunter mark first blood trails and to locate wounded animals while hunting.

### BACKGROUND

Hunters frequently have to track and find animals while hunting even after they may have initially fired a shot or bow to wound an animal. Hunters try to aim at the vital areas of an animal in order to kill them while hunting. However, animals are not always killed initially and may keep moving or running away even after being wounded, which is why hunters frequently have to track and find the wounded, dead, or dying animal even after having fired at them in a vital area.

To find a wounded animal, hunters will look for signs that the animal has gone to a particular location, including looking for signs of first blood. First blood is a term used by hunters to refer to any blood droppings or blood spots that appear to have fallen from the wounded animal that the hunter is tracking. During hunting, the hunter's shot draws enough blood to leave a trackable trail so that the hunter may find and claim the animal. This trackable trail is sometimes referred to as a “first blood trail.”

Hunters may hunt at night or during the day and usually are in dense woods or forests or other outdoor environments. It is difficult to find and track animals in general, and especially in such conditions. It is also very difficult to track a wounded animal and to correctly follow a first blood trail. Hunters may spend a lot of wasted time trying to track a wounded animal by going in circles and returning to the same initial blood spot that they located. This may result in the wounded animal getting away, not being found, or being found by another hunter.

There are some existing devices that exist to help a hunter looking for first blood and tracking a wounded animal. Such devices may include bright yellow or orange flags that may be tied to trees and/or branches. Further, there are some markers that clip to a tree or branch and include a reflective surface. However, these existing devices are deficient because they must first be tied onto a tree or other location. If a hunter is in a field, which sometimes is the case while hunting, then these types of tracking markers are not useful because the markers cannot be staked into the ground, but rather, must be tied or clipped to another object (e.g., such as a tree or bush). Further, these devices are not always easy to see as they may be hidden by trees, leaves, branches, or other natural elements.

Accordingly, there is still a great and unsolved need for a marker that may be use while hunting to track and find animals with a hunting marker that may be clearly visible to the hunter as well as easy to store and transport.

### SUMMARY

The present description includes one or more non-limiting embodiments for a hunting marker that may be used to mark a trail or to mark an indication of a hunted animal on the trail. In a non-limiting embodiment, the hunting marker may include a top section that may include one or more light emitting diodes (LEDs) and a pole having one or more cylindrical pieces. The one or more cylindrical pieces are configured to be extended or retracted. The hunting marker may further include a terminal end comprising a pointed end whereby the pointed end is configured to pierce a surface of a ground like a stake. The hunting marker may include one or more pieces of reflective tape located on the top section. The one or more pieces of reflective tape can be wrapped around one or more designated grooves located on the top section. The lower sections of the one or more cylindrical pieces of the pole are adapted to twist up into an uppermost section of the pole in order to retract within each other and to twist out in order to extend.

The body for the top section may further include a first piece and a second piece, whereby the first piece and the second piece are configured to be fit together in order to form the body of the top section. The first piece and the second piece are complimentary to one another. Further, the one or more cylindrical pieces are configured to collapse inwardly and extend in an outward direction and the one or more LEDs may be positioned on the top section or the pole body of the hunting marker, whereby the one or more LEDs are configured to be turned on and off as needed. The hunting marker may further include labels that are attachable to a portion of the hunting marker, whereby the labels include one or more alphanumeric symbols. The labels may be placed on the hunting marker in chronological order if more than one hunting marker is used to track the first blood trail.

Other aspects and advantages of the invention will be apparent from the following description and the appended claims.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 is a block diagram of a hunting marker in accordance with an illustrative embodiment.

FIG. 2 is pictorial illustration of a hunting marker in accordance with an illustrative embodiment.

FIG. 3 is a pictorial illustration of a top section of a hunting marker and a portion of a pole body of the hunting marker.

FIG. 4 is a pictorial illustration of a first piece for a top section of a hunting marker in accordance with an illustrative embodiment.

FIG. 5 is a pictorial illustration of a first piece and a second piece of a top section of a hunting marker and one or more light emitting diodes in accordance with an illustrative embodiment.

FIG. 6 is a pictorial illustration of a sectional view of an extending and retracting pole portion of the hunting marker in according with an illustrative embodiment.

FIG. 7 is a pictorial illustration of hunting markers in use in accordance with an illustrative embodiment.

FIG. 8 is a flowchart of an exemplary method of use of the hunting marker according to an illustrative embodiment.

### DETAILED DESCRIPTION

In the Summary above and in this Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, among others, are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm and upper limit is 100 mm.

Certain terminology and derivations thereof may be used in the following description for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The present disclosure is generally drawn to various embodiments for a hunting marker configured for use to track and find an animal. Notably, the hunting marker may be particularly useful to hunters because it is configured to extend to a full length and then to collapse or retract to a shorter length, which may make it particularly easy for storage in a hunter's backpack or other carrying case. Further, the hunting marker is made of durable materials that are sturdy and rugged to survive use in the outdoors while also being lightweight and easy to carry. In one non-limiting embodiment, the hunting marker may be entirely or partially made of bamboo. Alternatively, the hunting marker may be made from wood, bamboo, plastic, or a combination thereof. Further, the hunting marker may include a top end that includes reflective tape wrapped around the top end so that the hunting marker is easily visible to the hunter from afar, especially at night if the hunter is hunting an animal at night. Additionally, the hunting marker may further include a terminal end having a pointed end similar to a stake so that the hunting marker is easily inserted into the ground and stands upright and is easy to see from afar. Advantageously, the upright hunting marker may be more visible to a hunter than an item tied to a tree or branch as is the case with conventional, existing markers.

Additionally, in one or more non-limiting embodiments, the hunting marker may be configured so that one or more light emitting diodes (LEDs) is also located on a top end of the hunting marker, which may be activated as desired by a hunter to make the hunting marker more visible. Further, one or more labels may attach to the hunting marker, whereby the labels include numbers or letters that can be attached in chronological order to each hunting marker if more than one hunting marker is used. Accordingly, if a hunter uses three hunting markers while tracking an animal on a first blood trail, the first hunting marker may include a label with the number “1” or with the letter “A,” and each subsequent hunting marker has a label with the corresponding number or letter in chronological order (e.g., “2” or “B” or “3” or “C”) so that a hunter can easily follow the trail without getting lost. Such exemplary labels may better assist the hunter to understand the order of placement of the hunting markers. Additional details for the one or more embodiments of the present invention are provided below with respect to the drawings that illustrate the one or more embodiments and their method of use.

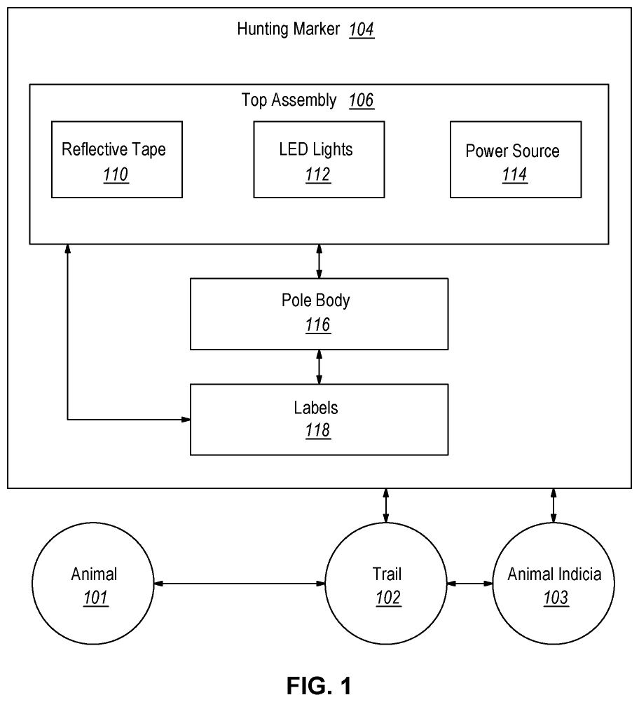

FIG. 1 is a block diagram of one or more components of a hunting marker in accordance with a non-limiting embodiment. In one or more non-limiting embodiments, hunting marker 104 may be used to mark locations on a trail 102 when tracking an animal, such as animal 101 shown in FIG. 1. Hunting marker 104 may be used to mark important locations that indicate the whereabouts of animal 101. Animal 101 may be any type of animal that a hunter may seek to hunt, including big game or small game. Types of big game that are commonly hunted include, but are not limited to, white-tailed deer, mule deer, moose, elk, caribou, bear, bighorn sheep, pronghorn, boar, javelina, and/or bison. Types of small game that are commonly hunted may include, but are not limited to, rabbit, hare, squirrel, opossum, raccoon, porcupine, skunk, ring-tailed cat, armadillo, and/or ruffed grouse. Many other types of animals may also be hunted, including, wild birds of various types or any other kind of animal 101.

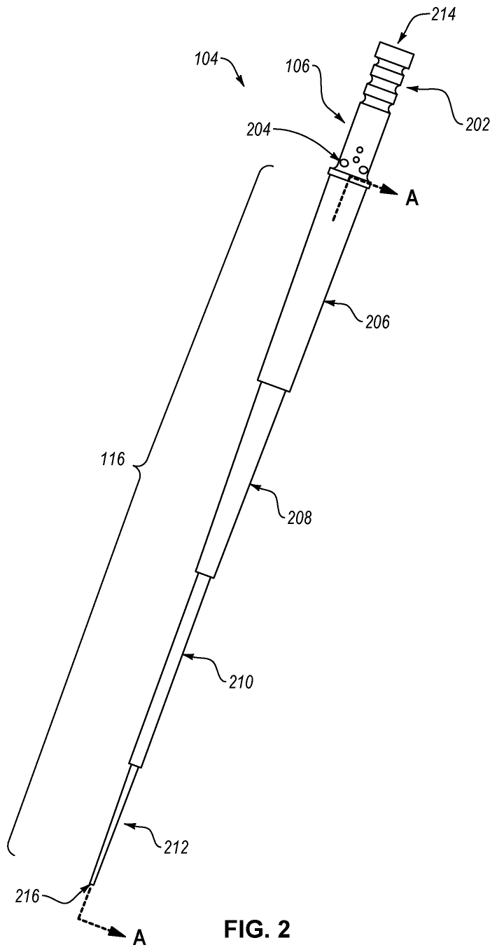

A hunter using hunting marker 104 may be hunting in any location, including one or more fields, forests, woods, plains, mountains, or any other location. Hunting marker 104 may be used for hunting animal 101 anytime during the day or the night. Hunting marker 104 may be useful to mark the spot of an animal based on found clues and indications of animal 101's presence, such as blood, fur, hair, or other indications that animal 101 has passed through a location during the day or night. Further, the hunter may be using the hunting marker 104 in any type of weather, including when there is ice and the ground is densely packed with ice, as the hunting marker 104 may have a pointed end (e.g., pointed end 216 shown in FIG. 2) that can pierce a frozen ground surface.

In one or more non-limiting embodiments, hunting marker 104 may be particularly useful for tracking an animal that may have been spotted and/or wounded on a type of trail 102 that is referred to as a “first blood trail.” Oftentimes, a hunter is able to fire at and wound an animal, but the animal may not instantly die and fall down in one place. Rather, the animal may continue moving and running away to hide in some obscure location. A hunter has to be able to track and follow such a wounded animal using the blood droppings on the trail 102, which is referred to as a first blood trail, as clues to the animal 101's whereabouts and final location. Accordingly, a first blood trail may be a type of trail 102 that a hunter tracks a wounded animal and looks for signs of blood or other indications of the animal on the surrounding terrain and in the surrounding environment. Such indications or signs may include, without limitation, blood spots, blood droppings, fur, hair, footprints, bent or broken leaves or branches, or any other signs of interest to the hunter.

In one or more non-limiting embodiment, hunting marker 104 may be formed from a top section or top assembly 106 that is connected to a pole portion 116 or pole body. The top section 106 may include pieces of reflective tape 110 that may be attached to one or more designated areas on the top section 106. The top section 106, in one or more non-limiting embodiments, may also include one or more LED lights 112, as well as a power source 114. The power source 114 may be used to provide power to the one or more LED lights 112. Such a power source 114 may include one or more batteries. In alternative embodiments, LED lights 112 may be solar powered or a combination, whereby the one or more batteries may also be supplemented with a solar powered battery. Additionally, or alternatively, it may be possible to include a charging port in order for the hunting marker 104 to be charged electronically by plugging into an electrical outlet or one or more computing or electrical devices, such as a user's smartphone or computer.

It is noted that the top assembly or top section 106 of the hunting marker 104 may act as a handle for the hunting marker 104 in that the user may easily grab hold of the top assembly 106 in order to grasp the hunting marker 104 and easily orient the hunting marker 104 to be inserted into a ground surface.

The pole portion or body 116 of hunting marker 104 may be an elongated, fixed body that makes up the main part of the hunting marker 104. In one or more non-limiting embodiments, the pole portion or body 116 may include more than one section that can extend and retract into one another, which is further shown in FIGS. 2-7. In alternative embodiments, the pole body 116 may fold upwards or downwards instead of collapsing inwardly and extending outwardly. It is preferable that the bottom end of the hunting marker 104 be pointed so as to easily insert into a hard ground surface that may be rocky, muddy, or may even constitute frozen ice if a hunter is hunting in an environment that has dense ice.

In one or more non-limiting embodiments, the hunting marker 104 is completely foldable and/or collapsible so that it may be folded and collapsed for easy storage and transport in any location. Various methods may be used to fold and/or collapse the hunting marker 104. In one non-limiting embodiment, hunting marker 104 may have telescopic sections that include one or more concentric tubular sections designed to slide into one another. In other non-limiting embodiments, hunting marker 104 may have hinged, folded sections that can be expanded and folded or retracted as needed. In other non-limiting embodiments, hunting marker 104 may include sections having threaded or press-fit ends that quickly join and separate, and a string that is central to the sections to hold the sections together. Other structures and methods may also be contemplated by one of ordinary skill in the art to ensure that hunting marker 104 is foldable and collapsible for easy carrying and storage.

To make hunting marker 104 particularly useful, in one or more non-limiting embodiments, the pole portion 116 of the hunting marker 104 may extend anywhere from 16 inches to 32 inches in height when in a fully upright, extended position, and when in a fully collapsed, folded position, may be 24 inches in height or less. This may make hunting marker 104 particularly easy and useful for a hunter to store one or more hunting markers 104 easily in his or her backpack or another location while hunting.

Further, hunting marker 104 may be made from any material. It may be preferable for hunting marker 104 to be as lightweight as possible. In one or more non-limiting embodiments, hunting marker 104 may be made from bamboo, plastic, wood, or a combination thereof. Other types of materials may also be used, including, without limitation, metal. Hunting marker 104 may be preferably lightweight but strong and sturdy to be used in outdoor environments. In one non-limiting embodiment, hunting marker 104 may be made having a bright orange color so as to be easily seen from afar during the day or nighttime. Other bright colors other than orange may also be used as known by those of ordinary skill in the art.

In one or more non-limiting embodiments, hunting marker 104 may include one or more pieces of reflective tape 110. Reflective tape 110 may be any type of reflective tape known in the art that includes an adherable inner surface and a reflective outer surface. Reflective tape 110 may be useful to add to all or a portion of hunting marker 104 so that hunting marker 104 is easily visible to the hunter from afar, especially at night. Accordingly, in one non-limiting embodiment, reflective tape 110 may be wrapped on the first end (e.g., such as the top end of the top section or assembly 106) of the pole 116. In other embodiments, reflective tape 110 may be wrapped around an upper part of the top section or assembly 106 as well as an entire length of the body of the pole 116 and terminate just above the lower terminal end of the pole 116.

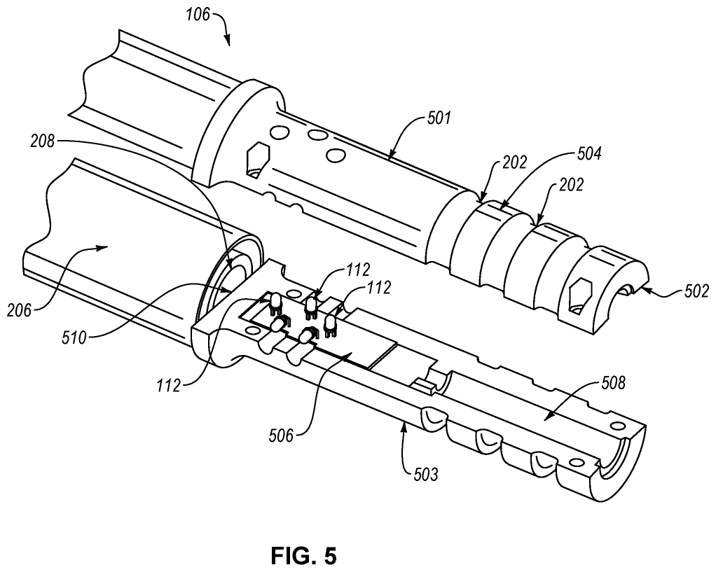

Alternatively, or additionally, in some non-limiting embodiments, hunting marker 104 may include an LED (light emitting diode) light, such as LED light 112 shown in FIG. 1 and in an example in FIG. 5. LED lights 112 may make hunting marker 104 even more visible to a hunter when in use. Accordingly, in some non-limiting embodiments, the hunting marker 104 may include a power source, such as power source 114 in order to activate LED lights 112.

It may be preferable for LED light 112 to be located near the top part of the hunting marker 106, such as on the top section 106 of the hunting marker 104. In some embodiments, hunting marker 104 may include both LED lights 112 and reflective tape 110 wrapped around all or a portion of top section 106 and/or pole 116. Accordingly, hunting marker 104 is easily visible to the user from afar via the use of the reflective tape 110 and/or LED lights 112.

In additional embodiments, it may be useful for hunting marker 104 to include one or more labels, such as labels 118. Labels 118 may constitute objects easily attachable to a top part of hunting marker 104, such as a part of the top section 106, or to the pole body 116 or to any part of hunting marker 104. The labels 118 may include numbers or letters or other symbols or images. Each label 118 can be added in chronological order to each hunting marker 104 if more than one hunting marker 104 is used by a hunter while tracking animal 101 on a trail 102 or when using hunting marker 104 for any purpose. For example, a hunter may need to use three hunting markers until he or she locates animal 101. If the hunter wants to clearly understand the order of placement of each hunting marker 104 so that the hunter knows if he or she has already covered a particular area, he or she may desire to add label 118 that indicates the order of placement for each hunting marker 104. Accordingly, a first hunting marker may be attached with a first label 118 having the number “1” or the letter ‘A,” a second hunting marker may have a second label 118 with the number “2” or the letter ‘B,” a third hunting marker may have a third label 118 with the number “3” or the letter “C,” and so on for as many hunting markers 104 as needed by the hunter to use while tracking animal 101 on the trail 102. As noted above, hunters may often be tracking animals 101 at night or in dense, wooded areas where it is difficult to know if one has already been over the same area or not. By using hunting markers 104, a hunter can clearly mark his or her trail 102 to understand one's location on the trail 102 and may also desire to use labels 118 to further avoid any confusion or loss of time. Labels 118 may be provided in any shape or size and may have various colors and designs. Labels 118 may be attached via adhesives or fasteners or any other means of attachment to hunting marker 104.

In one or more non-limiting embodiments, hunting marker 104 may include the name of the hunter or a name of a hunting party or group so as to clearly indicate who the hunting marker 104 belongs to. This may be helpful for hunting parties to determine which hunter initially wounded a particular animal and may help avoid any conflicts for who has the right to claim an animal.

Additionally, in other embodiments, the hunting marker 104 may include one or more protrusions (not shown) at the bottom end of the pole body 116 that a user may step on to make it easier to press the pole 116 into the ground with one or two feet.

It is noted that hunting markers 104 may also be used to mark any type of trail for a hunter even if the trail does not include first blood. For example, it may be useful for hunting markers 104 to be used to mark a trail while exploring in an outdoor environment for the hunter to find his or her way back to their tree stands, camp, truck, or another origin point so that the hunter does not get lost. It is noted that hunters often set up tree stands in unfamiliar territory so having the hunting markers 104 to mark their trail back to their tree stands (or other location) is very useful.

Turning to FIG. 2, FIG. 2 is a pictorial illustration of a non-limiting embodiment for hunting marker 104. As shown in FIG. 2, hunting marker 104 may include a top section 106 that is attached or attachable to the pole portion 116 of the hunting marker 104. The pole portion 116 is shown in FIG. 2 at its maximum length and in its fully extended position according to a non-limiting embodiment.

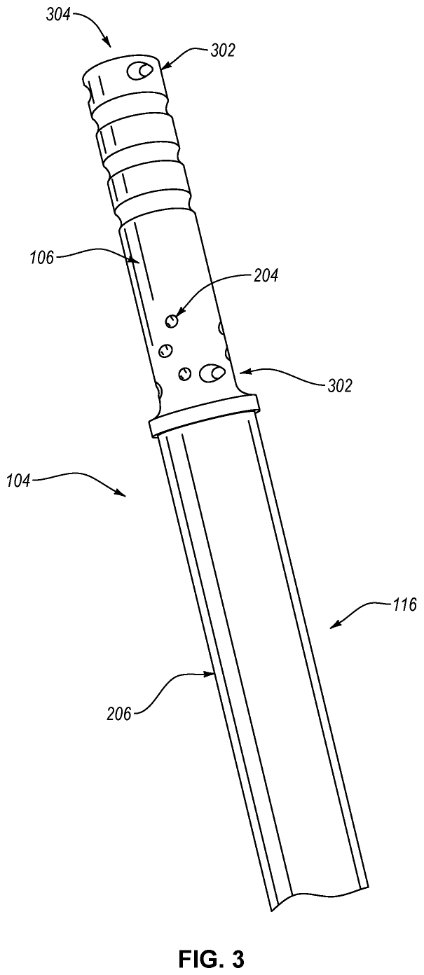

As noted above, the top section 106 can act as a handle for the hunting marker 104 and also provide other functions, including housing one or more batteries and other electronics to power the LED lights 112 as shown in FIG. 1 and FIG. 5. The top section 106 may include a top end or first end 214 of the hunting marker 104. Additionally, the top end 214 of the top section 106 (and of the hunting marker 104) may include a top cover (such as top cover 304 shown in FIG. 3) to cover the top section 106.

The top section 106 may include one or more grooves or designated areas 202 for one or more pieces of reflective tap 110 (as shown in FIG. 1) to be placed. Further the top section 106 may include one or more holes 204 that extend through an outer side through to an inner side of the body of the top section 106. The one or more holes 204 may be configured or adapted for one or more LED lights 112 to protrude through the one or more LED light openings or holes 204 in the top section 106.

In one or more non-limiting embodiments, the pole body 116 may include one or more sections, such as section 206, 208, 210, and 212. These sections 206-212 may be one or more cylindrically shaped sections in one or more non-limiting embodiments. In other embodiments, the one or more sections may have any shape as desired in the art, including square or rectangular or any other shape and configuration. The top section 206 may be wider than the next section 208, which may be wider than the next section 210. The ultimate or last section 212 in one or more non-limiting embodiments may be the thinnest of all the sections and may include a pointed end 216 that is configured to function as a stake that can be inserted into and effectively pierce a ground surface, including a hard or frozen ground surface.

In one non-limiting embodiment, the sections 212, 210, and 208 each twist up to fit within the interior bore of the first and widest section 206 when in a retracted position. Each subsequent section 208, 210, 212 after the first piece 206 of the pole 116 is able to telescopically extend outwards and retract back inwardly or collapse inwardly. In other embodiments, other means and mechanisms may be used to extend and retract the pole portion 116 of the hunting marker 104. For example, the pole body 116 may fold as a whole upwards towards the handle 106 so as to fold almost in half. Alternatively, in other embodiments, the sections (e.g., sections 206-212) of the pole body 116 of the hunting marker 104 may be threadably engaged with each other and can be connected and disconnected as needed by threading and unthreading the sections 206-212 together. Alternatively, the sections 206-212 may be configured so that the lowermost sections push up into each other and are contained within the top most section 206.

The retractability of the hunting marker 104 is an advantage because a hunter is not required to take up excess storage space in his or her backpack or other carrying bag or device or means of transportation. When in an extended position, such as that shown in FIG. 2, the pole portion 116 may range from 24-36 inches in length in one or more non-limiting embodiments, which makes it easier for a hunter to use and store hunting marker 104. One of ordinary skill in the art will understand that other lengths and dimensions may be used as well for hunting marker 104 and that the provided numbers are purely exemplary. Further, as noted above, it may be preferable for hunting marker 104 to be long, thin, and lightweight.

FIG. 3 shows an example of the hunting marker 104 focusing on the top section 106 and the upper part of the pole body 116 including the topmost section 206 of the pole body 116. FIG. 3 shows the top cover 304 that may be placed on the top end 214 of the top section 106. The top section 106 may include one or more holes 302 for screws or other fasteners to be used to fasten one or more pieces (e.g., first piece 501 and second piece 503 as shown in FIG. 5) of the top section 106 together. Further, the hunting marker 104 may include one or more openings 204 for LED lights 112. In the example shown in FIG. 3, the LED lights 112 are positioned towards a lower end of the top section 106 of the hunting marker 104. However, it is noted that in other embodiments, the LED lights 112 may be positioned closer to the upper portion of the top section 106 or scattered around all the parts of the top section 106. Further, while the holes 204 for the LED lights 112 are arranged in an asymmetric manner, in other embodiments, the holes 204 may be arranged symmetrically and in columns or straight lines.

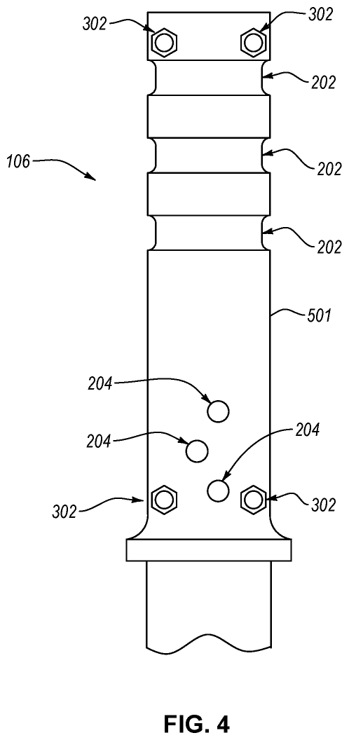

FIG. 4 and FIG. 5 are pictorial illustrations that primarily display the upper end of the hunting marker 104 according to a non-limiting embodiment of the top section 106. FIG. 4 shows a close up view of first piece 501 of top section 106 of the hunting marker 104 according to a non-limiting embodiment, while FIG. 5 shows an exploded view of the top section 106 as composed of two pieces.

First piece 501 may be one half of the top section 106, as shown in FIG. 4, and second piece 503 may be the other half of the top section 106. In one or more non-limiting embodiments, the first piece 501 and the second piece 503 of the top section 106 may be attached together to form the body of the top section 106. The first piece 501 and the second piece 503 may essentially be complimentary to each other.

The first piece 501 and second piece 503 may include fastener openings 302 distributed around the top and lower ends of the top section 106 in order for the first piece 501 to be fastened to the second piece 503 of the top section 106. It is noted that any other means of attachment may be used other than by fastening including, but not limited to, using adhesives, welding, soldering, VELCRO, or any other means of attachment as known in the art.

The first piece 501 (and second piece 503) may include one or more grooves 202 positioned next to a raised surface 504 (as shown in FIG. 5). The one or more grooves 202 may be designated areas on which one or more pieces of reflective tape 110 can be wrapped or placed. The reflective tape 110 ensures that the hunting marker 104 may be visible at night or in conditions where visibility is low. This may be particularly true if the LED lights 112 are not working or the batteries (e.g., power source 114) for the hunting marker 104 need replacing and it would be helpful for hunting marker 104 to include both reflective tape 110 and LED lights 112 to support each other and make it easier to see hunting marker 104 in all kinds of lighting and visibility. It is noted that in some embodiments, hunting marker 104 may not include reflective tape 112 but may just have the one or more grooves 202 anyways and instead rely on the integrated or embedded LED lights 112 to provide a glow or emit light from the top section 106 of the hunting marker 104. In other embodiments, hunting marker 104 may omit the use or integration of LED lights 112 and may instead solely include one or more pieces of reflective tape 110. Accordingly, various embodiments of hunting marker 104 may be made having both reflective tape 110 and LED lights 112, or just one or the other.

FIG. 5 shows that the first piece 501 has the same overall design and shape as the adjacent second piece 503. The first piece 501 and second piece 503 may include one or more compartments 508 designated for holding one or more batteries which acts as the power source 114 in one or more non-limiting embodiments for hunting marker 104. As shown in FIG. 5, the interior of top section 106, and specifically of the second piece 503, may include a designated spot for holding a LED power distribution board 506. The LED power distribution board 506 distributes power to the one or more LED lights 112 as obtained from the power source 114. While not shown, there may be one or more connectors to connect the LED power distribution board 506 of the LED lights 112 to the power source 114 in order to direct power to the LED lights 112.

The top end 214 of each first piece 501 and second piece 503 may include the opening or bore for the battery compartment 508. A top cover 304, as shown in an example in FIG. 3, may cover both the first piece 501 and the second piece 503 when the two pieces are joined together in one or more non-limiting embodiments.

FIG. 5 shows at least three LED lights 112 protruding away from the LED power distribution board 506. These LED lights 112 are configured to poke through or extend through the LED light openings 204 (e.g., as shown in FIGS. 3-4) so that the LED light 112 and/or emitted light from the diodes is visible from the outside of the top section 106 of the hunting marker 104. There may be one or more buttons or other types of selectors located on the top section 106 of the hunting marker 104 that a user may press in order to power on and off the LED lights 112. Alternatively, the user may twist the entire top cover 304 or top section 106 to power the LED lights 112 on and off.

Further, FIG. 5 shows that another section 208 (e.g., as also shown in FIG. 2) is in its retracted position and located within the interior bore of the top section 206 of the pole body 116. As noted above, in some embodiments, each subsequent section 208, 210, and 212 of the pole body 116 is capable of being twisted up into and contained or stored within an internal area or bore of the uppermost section 208 of the pole body 116 of the hunting marker 104.

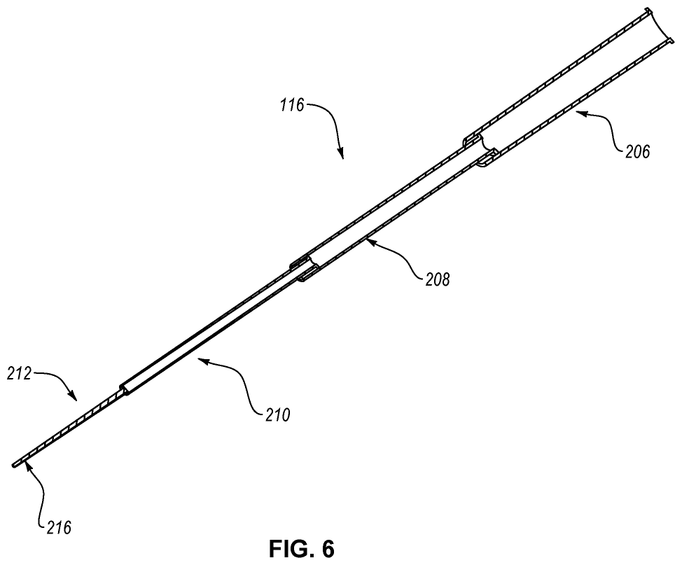

FIG. 6 provides a sectional view of the pole body 116 taken along line A-A shown in FIG. 2. As shown in its extended state, the pole body 116 has a top section 206 and then subsequently attached sections 208, 210, and 212. The end piece 212 may be the thinnest and pointiest shaped piece of the pole body 116 in one or more non-limiting embodiments culminating in a very pointed end 216 so that pointed end 216 may be inserted into the ground surface. The lowest section 212 is configured to retract upwardly into the next higher section, which is section 210, which is then configured to retract upwards into the next higher section 208, which is then configured to retract upwards into the highest and widest section 206 as shown in FIG. 6. In one non-limiting embodiment, the sections 208, 210, 212 can twist up or be pushed upward to all fit in the interior bore of the top section 206 of the pole body 116.

FIG. 5 further shows the attachment point 510 between the second piece 503 and the top section 206 of the pole body 116. In one or more non-limiting embodiments, the second piece 503 (or the first piece 501) may be attached to the topmost section 206 of the pole portion 116 of the hunting marker 104, while the other piece may then be separately connected or attached in order to form the whole top section 106 of the hunting marker 104. In one or more non-limiting embodiments, the whole pole body section 116 may be able to detach from the top handle 106 of the hunting marker 104 for even more modularity and to breakdown the pieces even more for easier storage.

In some embodiments, a user can press on one or more buttons to toggle or rotate through each of the LED lights 112 and turn on any of the LED lights 112. In another non-limiting embodiment, there may be a system assigned by the hunter to each selected light so that, for example, the first LED light among the set of LED lights 112 is selected to indicate a small amount of blood has been found on the trail 102, the second LED light may be selected to indicate a medium amount of blood has been found on the trail 102, and the third LED light may be selected to indicate a large amount of blood has been found on the trail 102. These are merely examples of how the user may choose to categorize each LED light of the set of LED lights 112 positioned on either the top section 106 the pole body 116 or both of the hunting marker 104. Alternatively, different LED lights of the set of LED lights 112 may be selected and assigned to indicate that different type of clues or animal indicia 103 have been found, such as blood, fur, hair, footprints, feces, or any other animal indicia 103.

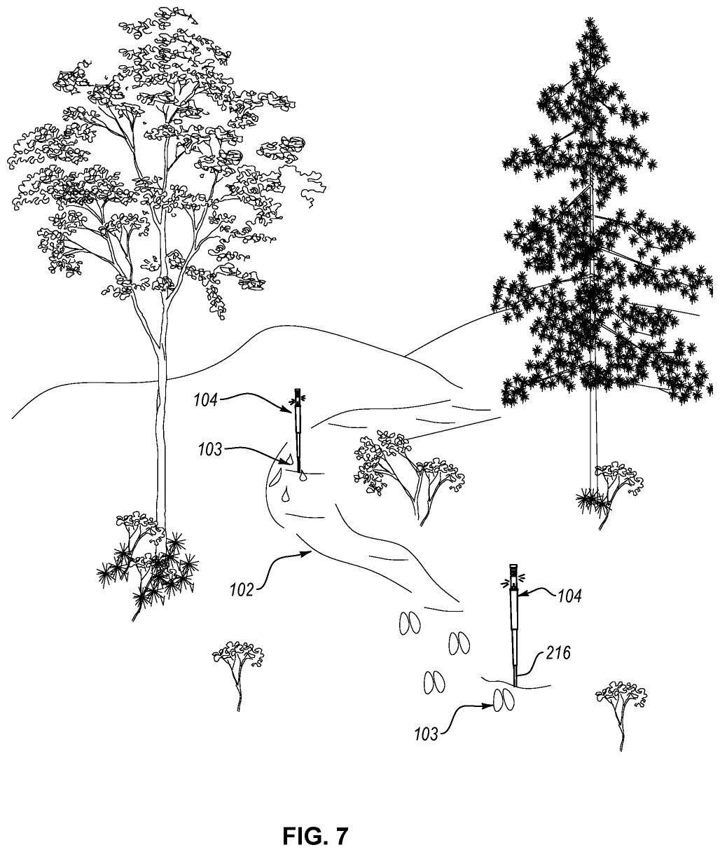

Turning to FIG. 7, FIG. 7 shows an example of hunting markers 104 in use in a field or wooded area. The hunting markers 104 are shown inserted into the ground along a trail 102. The hunting markers 104 shown in FIG. 7 may be in accordance with the description provided above with respect to FIGS. 1-6. As an example of how more than one hunting marker 104 may come in handy or be used by a hunter, there are two hunting markers 104 positioned on the trail 102 and shown in FIG. 7. Each hunting marker 104 may be inserted at a spot where there is an indication of animal 103. While hunting an animal along the trail 102, a hunter may have found blood droppings which are hard to spot especially at night and it may be beneficial for the hunter to mark this spot by inserting the hunting marker 104 to visually remind the hunter that he or she has already been to this spot and found a significant clue or indication that the animal has likely been to this spot before. As noted above, hunting marker 104 may include one or more LED lights 112 and/or pieces of reflective tape 110 to make it particularly easier to see hunting marker 104 when hunting whether during the day or the night.

Through actual use and testing, it has been found that hunting markers 104 are very helpful while tracking a wounded animal in preventing a hunter from becoming lost or confused in the outdoor environment about whether the hunter has already encountered a sign of the wounded animal (e.g., blood, prints, or other indicia). Further, hunting marker 104 may enable the hunter to find the wounded animal quicker so as to finalize the hunt and take the animal away.

On some occasions, a hunter may wound an animal, such as animal 101, and it may take time to find the animal 101. Having hunting markers 104 may be useful to mark the trail 102 so as to track animal 101 faster and more efficiently.

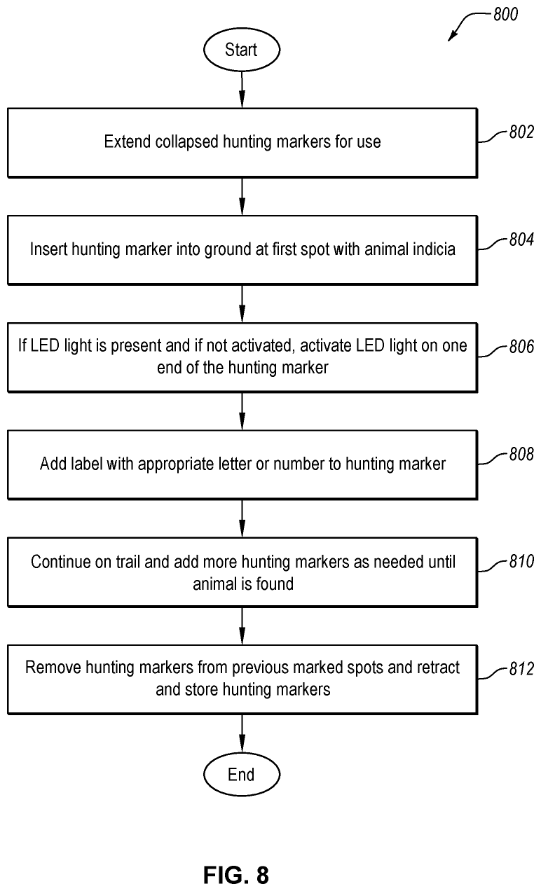

Turning to FIG. 8, FIG. 8 is a flowchart illustrating an exemplary method 800 of using hunting marker 104. The process may begin at step 802 in which a hunter may extend one or more collapsed hunting markers 104 for use while hunting and tracking animal 101. Hunting markers 104 may initially have been carried and stored by the hunter in their collapsed and retracted position in either a backpack or another means of transportation and taken to the initial tracking point on the trail 102.

At step 804, if a hunter finds indicia of the hunted animal 101, including, but not limited to, blood, footprints, fur, hair, or other signs of the animal, the hunter may then insert the hunting marker 104 into the ground at this first indicated spot. As noted above, hunting marker 104 may include reflective tape 110 wrapped around all or a portion of hunting marker 104, which may make hunting marker 104 clearly visible from afar to the hunter.

As noted at step 806, hunting marker 104 may also include an LED light, such as LED light 111, in which case, the hunter may activate the LED light 112 on the hunting marker 104 after having inserted hunting marker 104 into the ground. In some cases, the LED light may light up automatically and may not require the hunter to activate the LED light 112 because the LED light 112 is configured to detect when the hunting marker 104 is inserted into a ground surface.

Continuing with step 808, a hunter may choose to add a label, such as label 118 to indicate the order of placement of each hunting marker 104 if more than one hunting marker 104 is used to mark the trail 102. As noted above, labels 118 may include numbers and/or letters or other symbols or images to help a hunter understand the order of placement of the hunting markers 104 and may be added to each subsequent hunting marker 104 in chronological order.

At step 810, the process may continue with the hunter continuing on the trail 102 and adding more hunting markers 104 as needed until the hunter locates the animal 101 on the trail 102. Finally, at step 812, the hunter or another party may remove the hunting markers from previously marked spots. Part of this step may include turning off the LED lights 112 (if included), removing labels 118, and/or retracting and collapsing hunting markers 104 for easy storage and transport of the hunting markers 104 back to the hunter's desired location.

Accordingly, the present description provides for various embodiments for a hunting marker that is particularly helpful for hunters to use while tracking an animal on a hunting trail. The hunting marker, as described herein, in one or more non-limiting embodiments, may also be useful to mark any trail, whether or not the trail is a first blood trail or any other type of trail Further, it may be particularly useful for a hunter to use to help find their way back to their camp or origin point. Many uses and advantages are offered by the hunting marker 104 as described above in one or more non-limiting embodiments above.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. A hunting marker, the hunting marker comprising:
a top section, the top section comprising:
a body, the body comprising:
one or more light emitting diodes (LEDs); and
a pole body, the pole body comprising:
one or more sections, wherein the one or more sections are configured to be extended or retracted; and
a terminal end comprising a pointed end, the pointed end configured to pierce a surface of a ground,
wherein the hunting marker is adapted to mark a trail or to mark an indication of a hunted animal on the trail.

2. The hunting marker of claim 1, further comprising one or more designated areas or grooves located on the top section of the hunting marker.

3. The hunting marker of claim 2, wherein the one or more designated areas or grooves are configured to receive one or more pieces of reflective tape to be located on the top section of the hunting marker.

4. The hunting marker of claim 1, wherein lower sections of the one or more sections of the pole body are adapted to twist up into or otherwise push up into an uppermost section of the pole body in order to retract within each other and to twist out or push out in order to extend.

5. The hunting marker of claim 1, wherein the body for the top section further comprises:
a first piece;
a second piece, wherein the first piece and the second piece are configured to be fit together in order to form the body of the top section.

6. The hunting marker of claim 5, wherein the first piece and the second piece are complimentary to one another.

7. The hunting marker of claim 1, wherein the one or more sections are configured to collapse inwardly and to extend outwardly.

8. The hunting marker of claim 1, wherein the one or more LEDs are positioned on the top section or the pole body of the hunting marker.

9. The hunting marker of claim 1, wherein the one or more LEDs are configured to be turned on and off as needed.

10. The hunting marker of claim 1, further comprising labels that are attachable to a portion of the hunting marker, wherein the labels comprise one or more alphanumeric symbols, wherein the labels are configured to be placed on the hunting marker in chronological order if more than one hunting marker is used to track the trail.

11. A hunting marker, the hunting marker comprising:
a top section, the top section comprising:
a body, the body comprising:
one or more light emitting diodes (LEDs); and
one or more designated areas for one or more pieces of reflective tape to be wrapped around the one or more designated areas;
a pole body, the pole body comprising:
one or more pieces, wherein the one or more pieces are configured to be extended or retracted; and
a terminal end comprising a pointed end, the pointed end configured to pierce a surface of a ground,
wherein the hunting marker is adapted to mark a trail or to mark an indication of a hunted animal on the trail.

12. The hunting marker of claim 11, further comprising, one or more compartments for batteries and other electronics to power the one or more LEDs.

13. The hunting marker of claim 11, wherein lower sections of the one or more pieces of the pole body are adapted to twist up into an uppermost section of the pole body in order to retract within each other and to twist out in order to extend.

14. The hunting marker of claim 11, wherein the body for the top section further comprises:
a first piece;
a second piece, wherein the first piece and the second piece are configured to be fit together in order to form the body of the top section.

15. The hunting marker of claim 14, wherein the first piece and the second piece are complimentary to one another.

16. The hunting marker of claim 11, wherein the one or more pieces are configured to collapse inwardly and extend outwardly.

17. The hunting marker of claim 11, wherein the one or more LEDs are positioned on the top section or the pole body of the hunting marker.

18. The hunting marker of claim 11, wherein the hunting marker includes a top cover to cover a portion of the body of the top section.

19. The hunting marker of claim 11, further comprising labels that are attachable to a part of the hunting marker, wherein the labels comprise one or more alphanumeric symbols, wherein the labels are configured to be placed on the hunting marker in chronological order if more than one hunting marker is used to track the first blood trail.

20. The hunting marker of claim 11, wherein the one or more LEDs are configured to be turned on and off as needed.
